(19) United States
(12) Patent Application Publication
(10) Pub. No.: US 2006/0061207 A1
(43) Pub. Date: Mar. 23, 2006

(54) Spinner for bikes

(75) Inventors: Brian Kessler, Los Angeles, CA (US); Brian Mehler, Long Beach, CA (US); Scott Lubell, Los Angeles, CA (US)

Correspondence Address: BROWDY AND NEIMARK, P.L.L.C.;624 NINTH STREET, NW, SUITE 300, WASHINGTON, DC, 20001-5303, US

(73) Assignee: MAUI TOYS, INC., Los Angeles, CA (US)

(21) Appl. No.: 11/118,783

(22) Filed: May 2, 2005

Related U.S. Application Data
(60) Provisional application No. 60/566,408, filed on Apr. 30, 2004.

(51) Int. Cl. B60B 7/04

(52) U.S. Cl. 301/37.25

(57) ABSTRACT

A spinner assembly for wheels for bicycles and other vehicles is provided, which moves independently of the wheel axle and which can easily be adapted to fit a variety of axle sizes. The spinner assembly that is comprised of a spinner and a hub lock, the hub lock adapted to fit between the wheel hub and the spinner. The spinner may be formed of one unitary wheel with a slit from its outer circumference to its inner opening, or it may be split into multiple parts. The hub lock is provided in multiple parts. The spinner assembly is provided in multiple parts so that it can be slipped through the spokes of the bicycle wheel and easily assembled over the hub.

### FIELD

The present invention relates to a spinner assembly for wheels for bicycles, which moves independently of the wheel axle and which can easily be adapted to fit a variety of axle sizes.

### SUMMARY

An object of the present invention is to provide a spinner for bicycle wheels, which rotates independently of the wheel axle.

Another object of the present invention is to provide a spinner assembly that can be added to the bike wheels of fully assembled bicycles by the purchaser of the bicycle.

Another object of the present invention is to provide a spinner for bicycle wheels, which can easily be adapted to fit a variety of axle sizes.

Still another object is to provide a spinner for bicycle wheels, which rotates as the vehicle moves forward, and continues to rotate even after the vehicle has stopped.

Still another object is to provide a spinner, which is made in multiple parts so that it can be slipped through the spokes of the bicycle wheel and easily assembled over the hub.

Another object is to provide a spinner for bicycle wheels, which is decorative, simple in construction and economical to manufacture.

The scope and content of the present invention is not intended to be limited by or to the above mentioned objects.

Briefly, the invention according to one embodiment is characterized in particular by the use of a spinner assembly that is comprised of a spinner and a hub, lock, the hub lock adapted to fit between the wheel hub and the spinner. The spinner may be formed of one unitary wheel with a slit from its outer circumference to its inner opening, or it may be split into multiple parts. The hub lock is provided in multiple parts. The spinner assembly is provided in multiple parts so that it can be slipped through the spokes of the bicycle wheel and easily assembled over the hub.

### BRIEF DESCRIPTION OF THE DRAWINGS

For better understanding of the invention and additional objects and advantages thereof, reference is made to the following detailed description and accompanying drawing of a preferred embodiment, wherein

FIG. 1 is a plan view of a first embodiment of a spinner assembly in accordance with the present invention;

FIG. 2 is an partial expanded view taken on a plane of the line 2-2 of FIG. 1;

FIG. 3 is an expanded perspective view showing the snap lock latch used in the spinner assembly according to the first embodiment of the present invention;

FIG. 4 is a perspective view showing the snap lock latch in its closed position according to the first embodiment of the present invention;

FIG. 5 is an exploded top view of the spinner assembly according to a second embodiment of the present invention;

FIG. 6 is a perspective view of one side of a hub lock according to the second embodiment of the present invention;

FIG. 7 is a perspective view of another side of the hub lock of FIG. 6 according to the second embodiment of the present invention;

FIG. 8 is a cross-section view of the hub lock of FIG. 6 according to the second embodiment of the present invention;

FIG. 9 is a perspective view of the spinner according to the second embodiment of the present invention;

FIG. 10 is a top perspective view of the spinner assembly according to the second embodiment of the present invention;

FIG. 11A is a plan view of the bottom of the male hub lock according to the second embodiment of the present invention;

FIG. 11B is a side view of the male hub lock according to the second embodiment of the present invention;

FIG. 11C is a perspective view of the bottom of the male hub lock according to the second embodiment of the present invention;

FIG. 11D is a perspective view of the top of the male hub lock according to the second embodiment of the present invention;

FIG. 11E is a side view of the male hub lock according to the second embodiment of the present invention;

FIG. 11F is a plan view of the top of the female hub lock according to the second embodiment of the present invention;

FIG. 11G is a side view of the female hub lock according to the second embodiment of the present invention;

FIG. 11H is a perspective view of the top of the female hub lock according to the second embodiment of the present invention;

FIG. 11I is a perspective view of the bottom of the female hub lock according to the second embodiment of the present invention;

FIG. 11J is a side view of the female hub lock according to the second embodiment of the present invention;

FIG. 11K is a plan view of a portion of the top of the assembled hub lock according to the second embodiment of the present invention;

FIG. 11L is a side cross-sectional view of a portion of the assembled hub lock along the line B-B of FIG. 11K according to the second embodiment of the present invention;

FIG. 12 is a perspective view of the assembled spinner according to a third embodiment of the present invention;

FIG. 13 is an exploded perspective view of the spinner according to the embodiment shown in FIG. 12;

FIG. 14 is an illustration of a C-ring guide provided with the spinner according to one embodiment of the present invention;

FIG. 15 illustrates the placement of the C-rings used in the embodiment shown in FIGS. 12 and 13;

FIG. 16 illustrates the placement of the spinner according to the present invention during installation on the bicycle wheel;

FIG. 17 illustrates the placement of the spinner according to the present invention after installation on the bicycle wheel;

FIG. 18 is a close-up view of one of the hub locks according to the present invention after installation on the bicycle wheel;

FIG. 19 is an exploded view of the spinner and hub locks during installation according to the embodiment of FIGS. 13 and 14;

FIG. 20 is a close-up view of the hub locks and spacer clamps installed on the bicycle wheel hub according to one embodiment of the present invention;

FIG. 21 illustrates the spinner installed on a bicycle wheel according to the present invention;

FIGS. 22A and 22B illustrate the spacer clamp in an expanded position and a squeezed position, respectively, according to one embodiment of the present invention;

FIG. 23 illustrates the angles used in constructing one of the hub locks according to one embodiment of the present invention;

FIG. 24 is a side view of one of the hub locks according to one embodiment of the present invention;

FIG. 25 illustrates the angles used in constructing one of the hub locks according to one embodiment of the present invention;

FIG. 26 is a side, partial cross-sectional view of the hub lock taken along the line 26-26 of FIG. 25;

FIG. 27 is a cross-sectional view of the hub lock taken along the line 27-27 of FIG. 24;

FIGS. 28A and 28B are perspective views of two of the hub locks according to the embodiment of the present invention shown in FIG. 13;

FIG. 29 is a cross-sectional view of the hub lock taken along the line 29-29 of FIG. 24;

FIG. 30 is a detailed view of the portion of FIG. 29 surrounded by a dashed line;

FIG. 31 is a perspective view of a C-ring according to one embodiment of the present invention;

FIG. 32 is a top view of a spinner according to a fourth embodiment of the present invention;

FIG. 33 is a top view of a spinner according to a fifth embodiment of the present invention; and

FIG. 34 is a perspective view of the spinner shown in FIG. 33.

### DETAILED DESCRIPTION

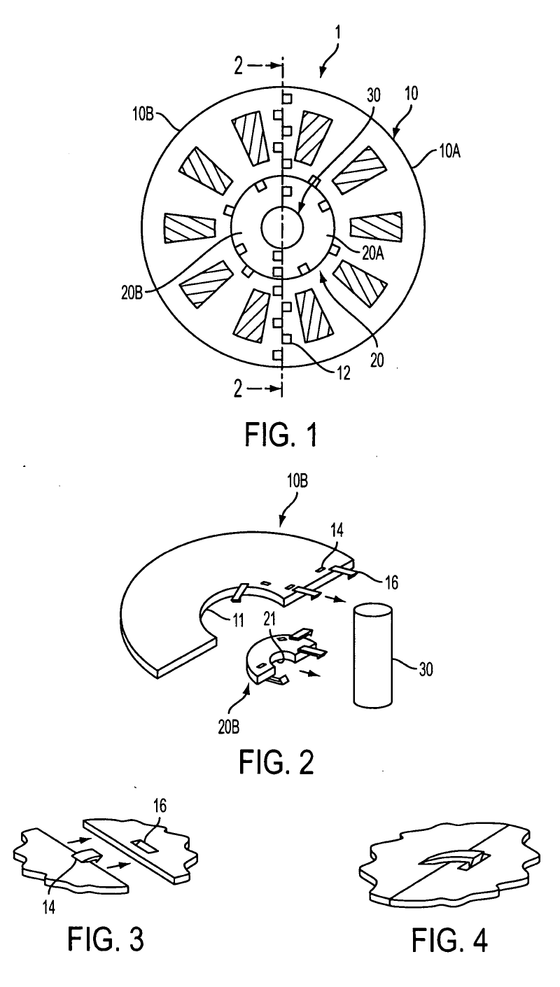

Referring now in detail to the drawings, in FIGS. 1-4 there are shown a spinner assembly 1 according to a first embodiment of the present invention. The spinner assembly includes a spinner 10 and a hub lock 20. The hub lock 20 is sized to fit on the hub 30 of the bicycle wheel.

According to the first embodiment, the spinner 10 is formed of at least two members 10A and 10B and the hub lock 20 is also formed of at least two members 20A and 20B. According to the first embodiment, each member forms half of the spinner and hub lock, respectively, and is in a semicircular configuration. It is contemplated within the skill of the ordinary artisan that the spinner and the hub lock may be divided in more than two parts, for example 3 or more sections could be used for each. As shown in FIG. 2, according to one embodiment, each member 10A and 10B has a cutout portion 11 in its inner portion, which is sized to receive a corresponding member 20A or 20B of the hub lock 20. Each member 20A and 20B has a cutout portion 21 in its center inner edge portion, which is sized to fit around the hub 30 of the bicycle. The size of the cutout portion 21 may be varied to accommodate a plurality of different sized bicycle wheel hubs. The cutout portions are sized so that the hub lock 20 and spinner 10, when assembled, are able to rotate independently of the rotation of the hub.

The two members 10A and 10B and the two members 20A, 20B are connected together to form the spinner 10 and the hub lock 20, respectively, through connectors. Likewise, the spinner 20 is connected to the hub lock 10 through connectors. According to one embodiment, the connectors are snap and lock latches 12, which are formed by a tab 16 provided on one side and a dimple 14 formed in the other side into which the tab 16 is to be snapped. One of ordinary skill will appreciate that other connectors can be used to accomplish the securing of the two members of the spinner and hub lock to one another and the spinner to the hub lock.

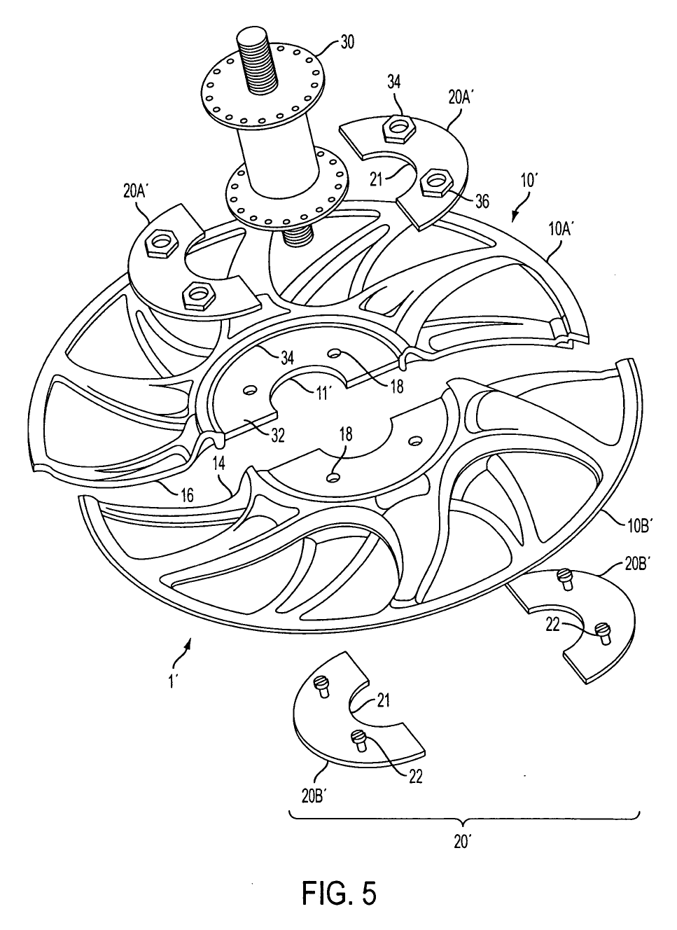

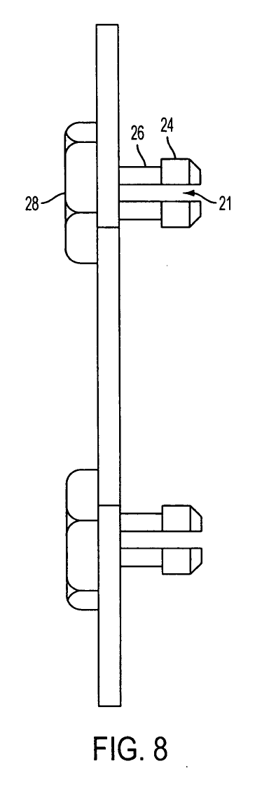

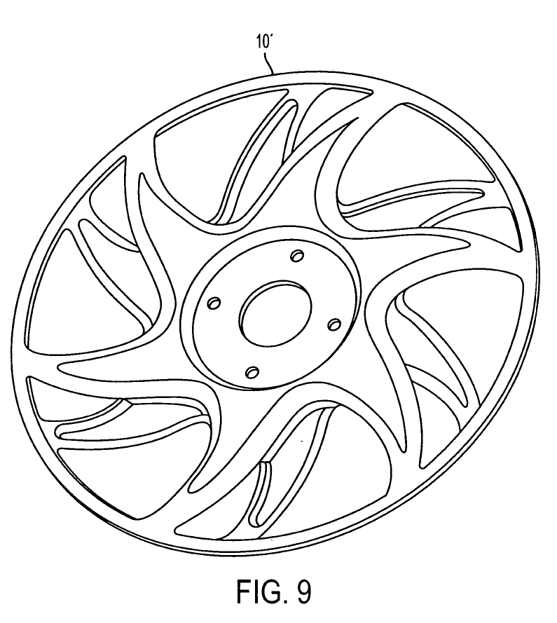

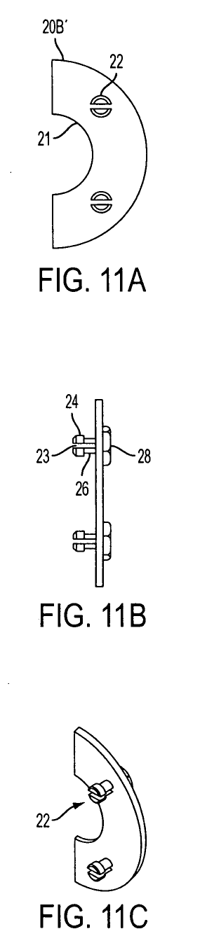

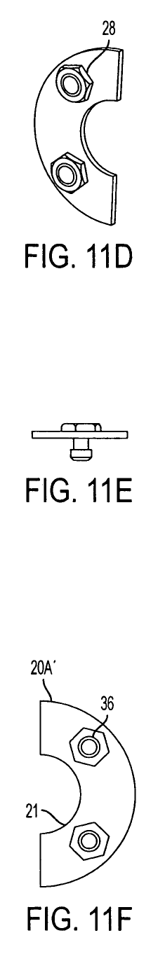

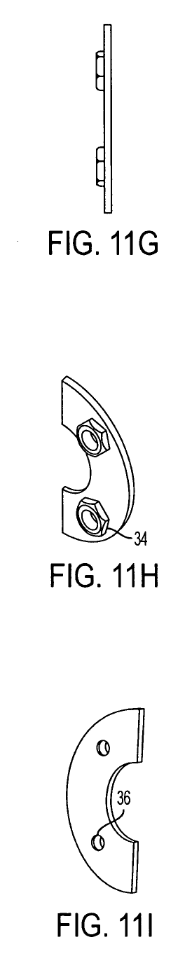

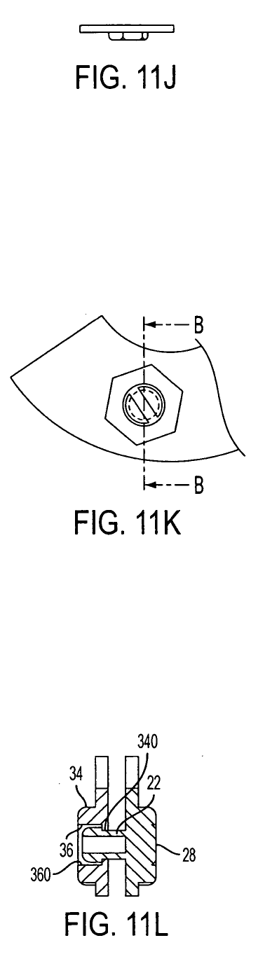

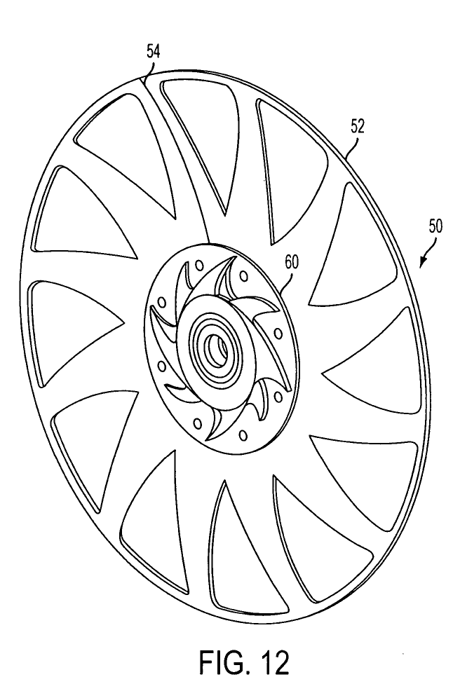

FIGS. 5-10 show a spinner assembly 1′ according to a second embodiment of the present invention. FIGS. 11A-11L show various views of the male and female hub lock members and the assembled hub lock according to this embodiment. The spinner assembly includes a spinner 10′ and two hub locks 20′. According to this embodiment, the spinner 10′ is formed of two members 10A′ and 10B′. As in the first embodiment, each member forms half of the spinner and is in a semicircular configuration. Each member 10A′ and 10B′ has a cutout portion 11′ in its center inner edge portion, which is sized to fit the hub 30 of the bicycle wheel.

As in the first embodiment, the hub locks 20′ are sized to fit on the hub of the bicycle wheel. In this embodiment, the two hub locks 20′ are provided as four separate members. There are two male members 20B′ and two female members 20A′ that snap over the two spinner members 10A′, 10B′ at the part line securing them together. According to this embodiment, the two hub locks 20′ are also each formed of two semicircular members 20A′ and 20B′ respectively. As in the first embodiment, it is contemplated within the skill of the ordinary artisan that the spinner and the hub locks may be divided in more than two parts, for example 3 or more sections could be used for each.

Each member 20A′ and 20B′ has a cutout portion 21′ in its inner portion, which is also sized to fit around the hub 30 of the bicycle. The size of the cutout portions 11′ and 21′ may be varied to accommodate a plurality of different sized bicycle wheel hubs. As in the first embodiment, the cutout portions are sized so that the hub locks 20A′ and 20B′ and the spinner 10′, when assembled, are able to rotate independently of the rotation of the hub.

The two members 10A′ and 10B′ are connected to one another directly through connectors. According to the second embodiment, the connectors are snap and lock latches similar to that described with respect to the first embodiment (not shown).

Alternatively, the members 10A′, 10B′ are connected to the hub member 20A′, 20B′, through holes 18 provided in the spinner 10′, thus effectively connecting the member 10A′ to member 10B′ and hub members 20A′ and 20B′ to one another, respectively. In this embodiment, as illustrated in FIGS. 5-11, the spinner members 10A′, 10B′ are each provided with a thinner semicircular recessed portion 32. The recessed portion 32 is surrounded on its outer circumference by a ridge 34, such that the hub lock members 20A′ and 20B′ fit within the recessed portion 32 when the spinner assembly is attached to the wheel hub 30. At least one through hole 18 (shown in this embodiment as two holes on each semicircular recessed portion 32) is drilled in the recessed portions 32.

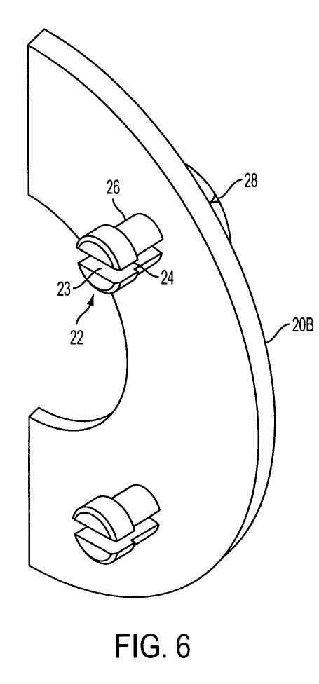

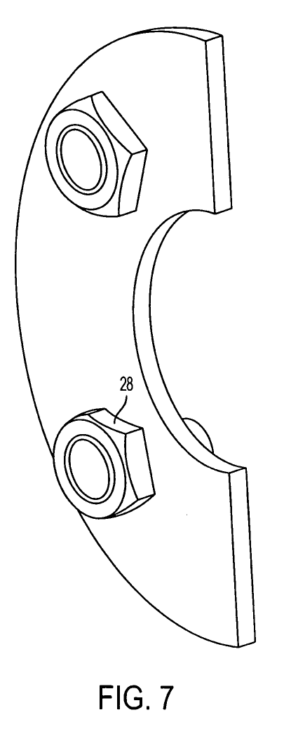

As illustrated in FIGS. 5 and 11A-E, each member of the hub lock 20A′ includes at least one (shown in this exemplary embodiment to be two) nut 34. Holes 36 are drilled through the female hub lock 20A′ members and the nuts 34. As illustrated in FIGS. 6-7 and 11F-J, in corresponding positions on the male hub lock members 20B′, pegs 22 protrude from one surface of the male hub lock members 20B′. Nuts 28 are provided in corresponding positions on the opposite surface of the hub lock members 20B′. According to this embodiment, the nuts 28 are molded as decorative features, and are not functional, as they have no threads.

As seen, e.g., in FIG. 6, the pegs 22 include a flange 24 and a shaft 26 between the flange 24 and the surface of the male hub lock members 20B′. According to the embodiment shown in FIGS. 6, 8 and 11B, the pegs 22 may be split in a center portion 23 thereof. As shown in FIG. 11L, the holes 36 have a narrow portion 340 towards the entrance of the hole and a wide portion 360 to accommodate the flange 24 of the peg 22 at the end of the hole. When the spinner assembly is put together, the two members of the pegs 22 are squeezed together and inserted into the through holes 18 and into the holes 36 in the female hub lock 20A′ members (see FIG. 11L).

As an alternative embodiment, instead of the snap pins, conventional notes and bolts may be used to hold the hub locks in place. It is within the skill of the artisan to fashion other means for holding the hub locks in place on either side of the spinner.

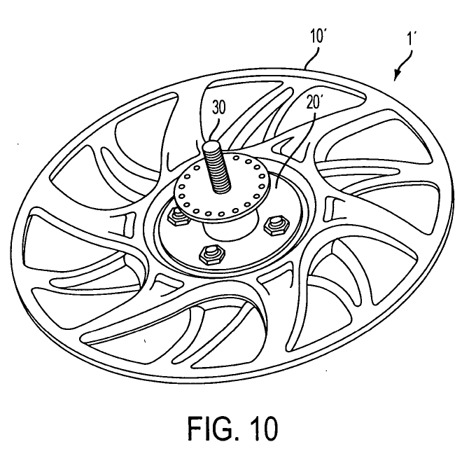

The hub lock halves 20B′ rest in the recessed portions 32 of the spinner 10′. In this manner, the two hub locks 20A′ and 20B′ are held in place on either side of the spinner 10′. FIG. 9 illustrates the spinner 10′ in its entirety, and FIG. 10 illustrates the spinner 10′ and hub 20′ connected to the hub 30, according to the second embodiment of the invention.

FIGS. 12-14 illustrate a third embodiment of the present invention. According to this embodiment the spinner 50 includes a single large center disk 52 in one piece with a single slit 54 from outer edge to center 56, two hub locks 60 and 70, and at least one C-ring 80, 82, 84, or 86 to fit over the bicycle hub (not shown). The single disk 52 can be easily spun through the bicycle spokes and onto the bicycle hub using the single slit 54.

The hub locks 60, 70 are each formed in two parts 62, 64 and 72, 74, respectively, that snap together over the spinner disk 52 and bicycle hub to hold the large spinner disk 52 in place and rotate with the spinner 52 around the wheel hub 30. Once the spinner disk 52 and the four hub lock parts 62, 64, 72, and 74 are fitted over the hub, they are snapped together using holes 58 and 88 and pins 22.

Each hub lock part 62, 64 and 72, 74 includes an inner circumference consisting of three sections 68a, 68b, 68c, 69a, 69b, and 69c, and 78a, 78b, 78c, 79a, 79b, and 79c. Sections 68b, 69b and 78b, 79b define a center hole that will fit around the bicycle wheel hub 30. Sections 68a, 69a, and 68c, 69c of hub lock parts 62, 64, and sections 78a, 79a, and 78c, 79c of hub lock parts 72, 74, come together, respectively, when the hub locks are put on the bicycle wheel hub 30 to provide a wider stance at the hub to reduce wobbling of the spinner 52.

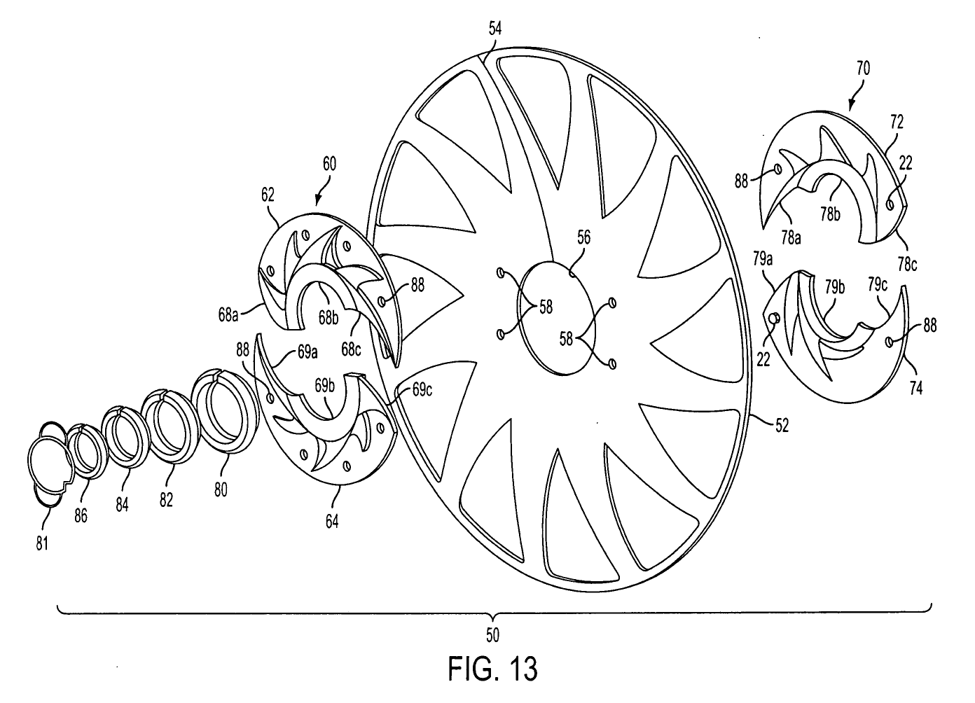

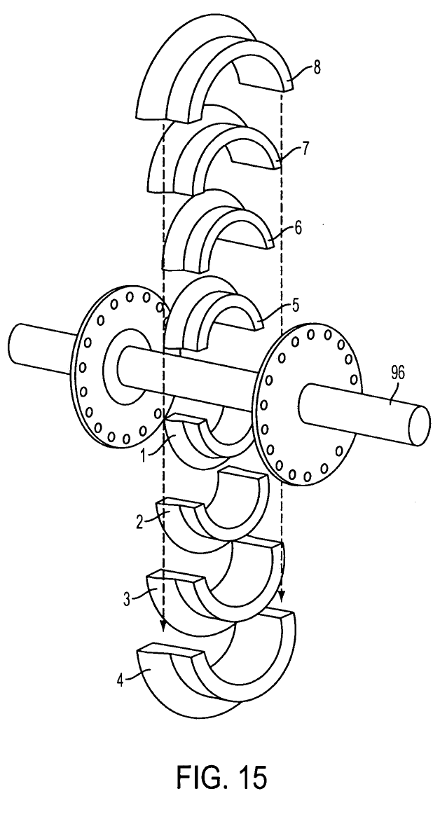

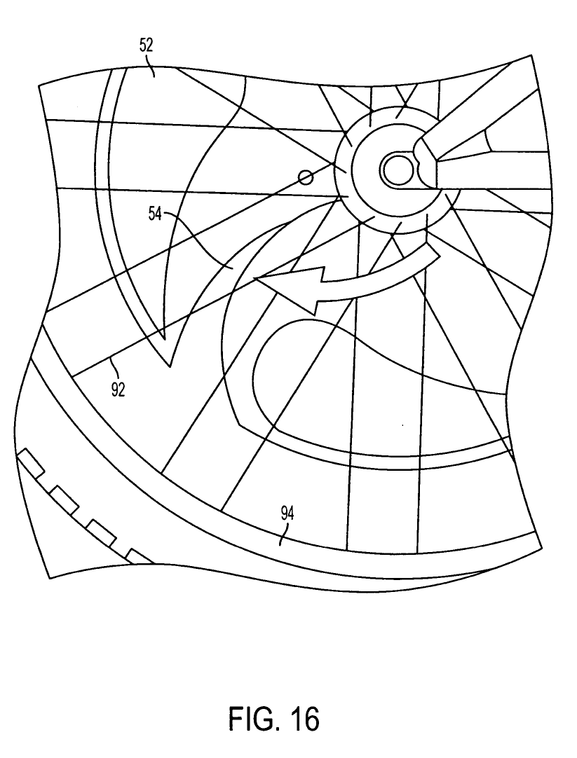

Various sized C-rings 80, 82, 84, 86 may be used individually or in combination to fit over the wheel hub 30 dependent on the size of the hub. The C-rings may be formed of a single ring, with one slit (as shown in FIG. 13) or in two parts (as shown in FIG. 15). A C-ring clamp 81 is added on the end of the C-rings to make sure the spinner 52 stays centered on the wheel hub 30.

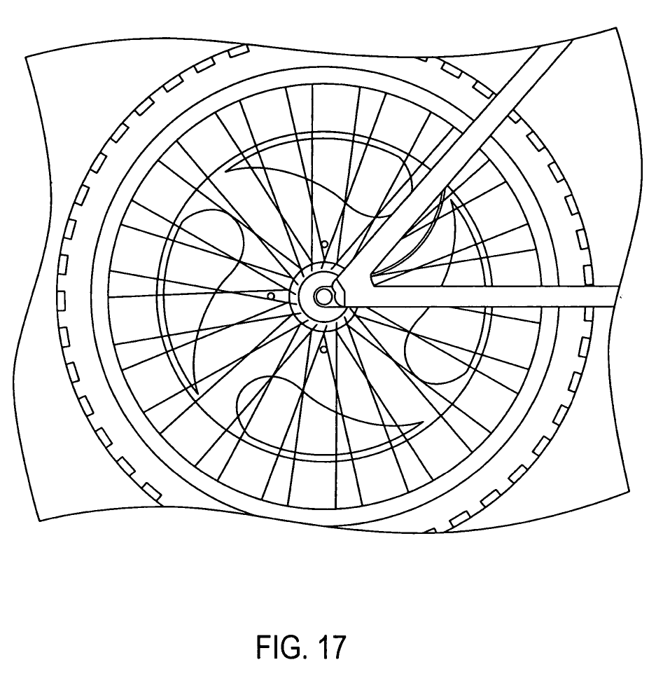

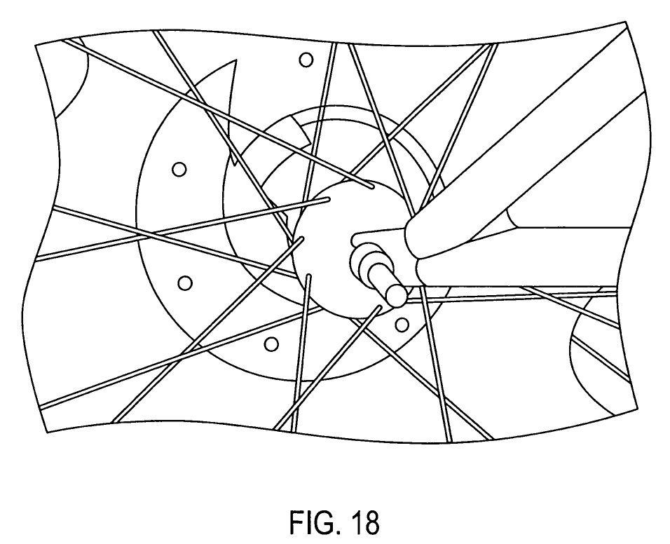

The method of installing the spinner assembly according to the present invention on a bicycle or other wheeled vehicle will be explained with reference to FIGS. 13-21. All of the parts that are part of the spinner assembly 50 according to this embodiment of the present invention are shown in exploded view in FIG. 13. For easiest installation, the bicycle should be flipped over to allow easy access to the wheel. Prior to installation, the wheel hub 30 should be wiped with a soft rag to clean any debris.

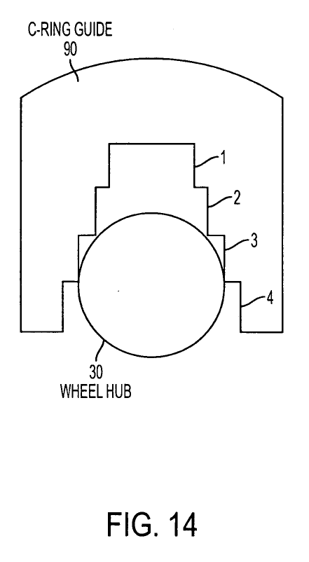

A C-ring guide 90 of the type shown in FIG. 14 can be used to determine the required number of C-rings. A C-ring guide 90 is provided with the spinner assembly. If the C-ring guide 90 does not fit over the wheel hub 30, no C-rings are required for proper assembly of the spinner assembly 50.

Referring to FIG. 16, the spinner 52 is rotated around the bicycle frame so it is up against the spokes 92. The spinner 52 is then twisted slightly and inserted through the spokes 92 at the slit 54. Next, the spinner 52 is rotated until it is completely inside the wheel 94. The first piece, e.g., 62 of the hub lock 60, can then be inserted through the spokes 92, into the designated holes 58 in the center of the spinner 52. The hub lock 60 should be held in place, using tape, if necessary. The second hub lock 72 can then be inserted on the opposite side of the spinner 52, lining up with the same holes 58 and snapped into place.

To install the first half set of C-rings (the number having been determined using the C-ring guide 90 of FIG. 14), one half set 1, 2, 3, and 4 of the C-rings (see FIG. 15), are placed onto the axle 96. The half set should be held in place, and the spinner 52 rotated around the C-rings 1-4 until it fits inside the hub locks 62, 72. The spinner and C-rings should be held in place. The second half 5, 6, 7, and 8 of the C-rings should then be installed by placing them on the axle 96. The spinner 52 should then be moved into place, lining up with the first half of the C-rings 1, 2, 3, and 4, and the C-rings should be pressed together until they snap (see FIG. 15 and 18).

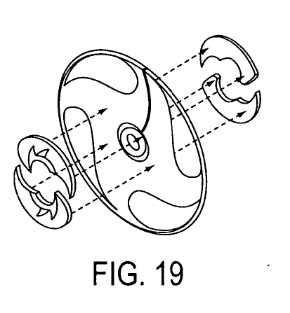

The third piece 64 of the hub lock 60 can then be inserted through the spokes 92, to line up with designated holes 58 of the spinner 52, and held in place, using tape if necessary. The fourth piece 74 of the hub lock should then be inserted on the opposite side, lining up with the same holes 58, and snapped in place (see FIG. 19). The hub locks 60, 70 should be snapped tightly together by pressing firmly from opposite sides.

A piece of tape, such as a metallic tape, should be wrapped over the slit 54 to cover both sides of the spinner 52. This will keep the edge of the slit 54 from catching on the spokes 92 (see FIG. 21).

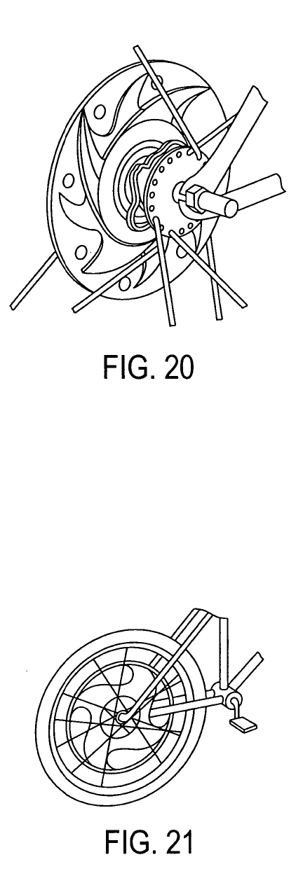

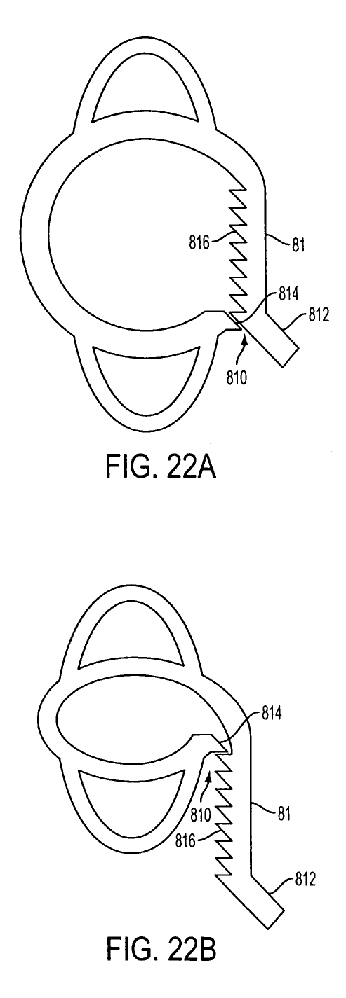

The spacer clamps 81 (shown in FIGS. 22A and 22B) keep the spinner 52 centered on the wheel hub 30. If C-rings (1, 5), (2, 6) or none were used, large clamps should be used. If C-rings (3, 7) or (4, 8), small clamps will be needed. As many clamps should be used on both sides of the spinner 52 as is necessary to keep the spinner 52 centered on the wheel hub 30. The clamp spacing should be kept loose, to allow for free spinning (see FIG. 20). To install space clamps 81, the tip 812 of the clamp 81 should be pressed onto the axle 96, forcing the jaw 810 open, then clamped shut by squeezing the clamp 81 back together with a click. The inside tip 814 will click along the teeth 816 as the clamp is squeezed, forming a tight (but not too tight) clamp on the axle 96.

After the hub locks 60, 70 and the spacer clamps 81 are snapped in place, the wheel 94 can be spun. The spinner 52 will spin independently of the wheel 94 as the bicycle moves during normal riding activities.

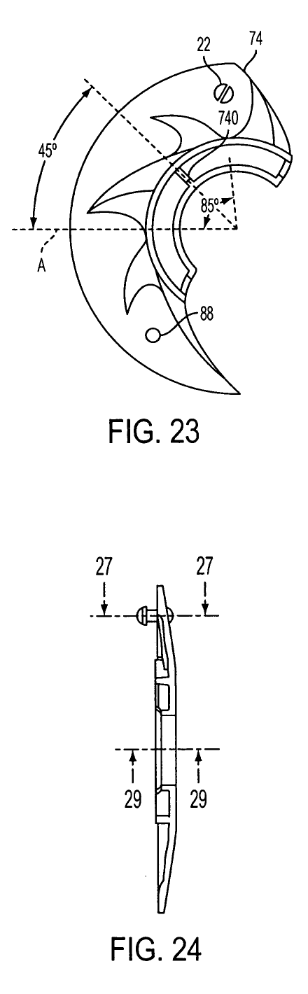

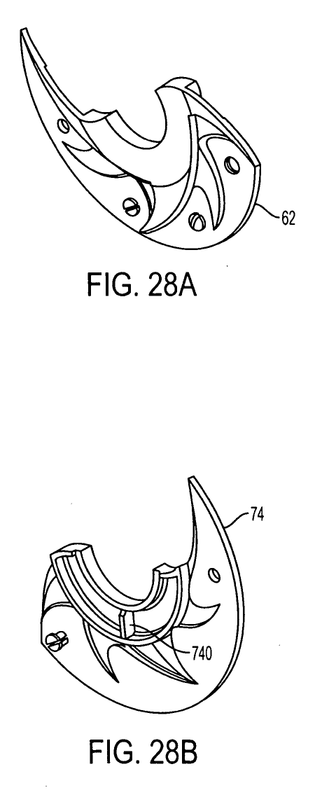

FIGS. 23-30 illustrate the detailed construction of the hub locks 60, 70 according to one embodiment of the present invention. FIG. 23 illustrates a top view of one half 74 of the hub lock 70. The angles shown in FIGS. 23-30 are designed so that the hub lock halves 62, 64 and 72, 74 are mirror images with respect to one another and fit together precisely. As seen in FIG. 23, an 85° angle is provided between the horizontal (dashed line A) and the center of the peg 22. A 45° angle is provided between the dashed line A and a divider 620 provided in the center portion of the hub lock half 74 (see FIG. 28B).

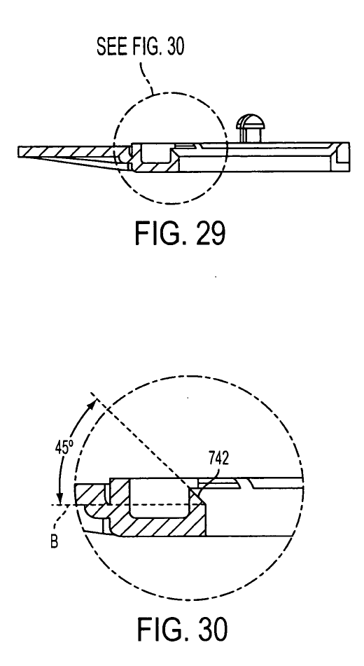

FIG. 24 illustrates a side view of the hub lock half 74 of FIG. 23. FIG. 27 illustrates a cross-sectional view of the hub lock half 74 taken along the line 27-27 of FIG. 24. FIG. 29 illustrates a cross-sectional view of the hub lock half 74 taken along the line 29-29 of FIG. 24.

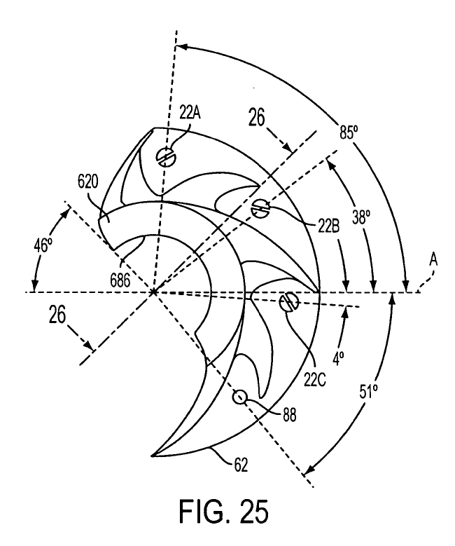

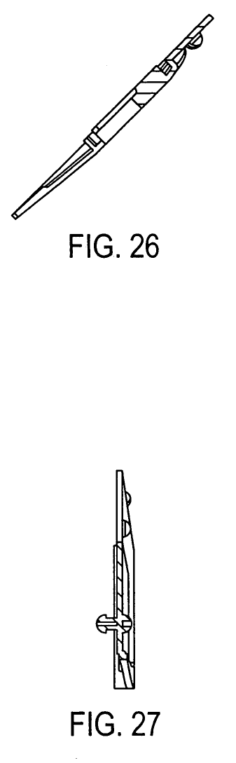

FIG. 25 illustrates a top view of the half 62 of the hub lock 60. FIG. 26 illustrates a cross-sectional view taken along the line 26-26 of FIG. 25. Here again, there is an 85° angle between the horizontal dashed line A and the end pin 22A. Pins 22B and 22C are provided for cosmetic reasons only. There is a 38° angle between the horizontal dashed line A and the second pin 22B. Further, there is a 4° angle between the horizontal dashed line A and the third pin 22C. There is a 51° angle between the dashed line A and the hole 88. Finally, there is a 46° angle between the horizontal dashed line A and the end 620 of the portion 68b of the hub lock half 62.

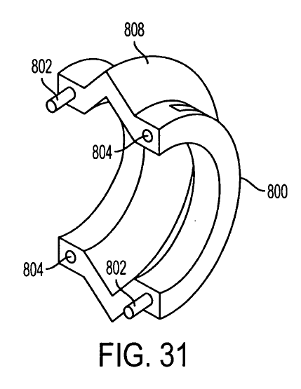

FIGS. 28A and 28B are perspective views of the hub lock halves 62 and 74, respectively. FIG. 30 is a detailed view of the portion of FIG. 29 shown in a circular dashed line. The inner surface 742 of the hub lock half 74 is formed so as to have a 45° angle with respect to the horizontal dashed line B.

FIG. 31 illustrated one embodiment of each half 800 of the C-rings, which can be used in accordance with the present invention. The C-ring halves 800 are semicircular, and have at each end one pin 802 and one hole 804. The pins 802 and holes 804 are sized and positioned so as to be snapped together when two halves 800 are fitted around the wheel hub 30. The halves 800 may be constructed with a V-shaped ridge 808 in the mid-section of the half. When two C-rings are place one on top of the other, the V-shaped ridges 808 mate with one another so that the C-rings remain fitted on top of one another.

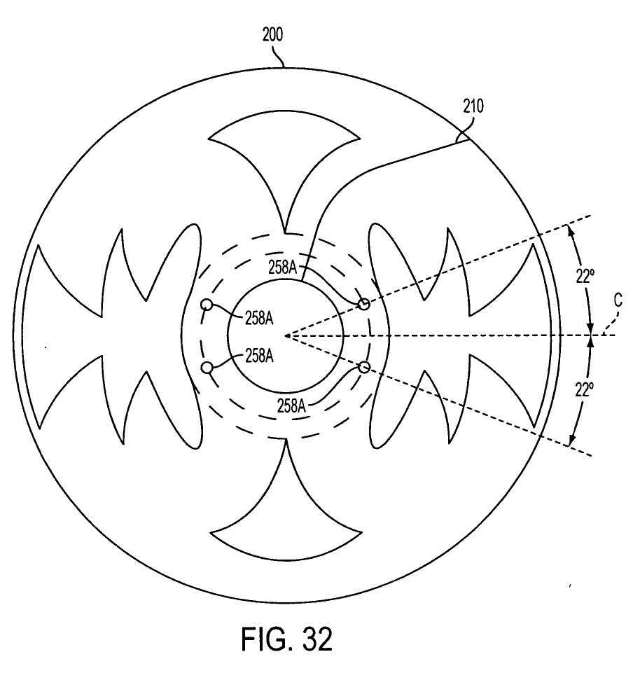

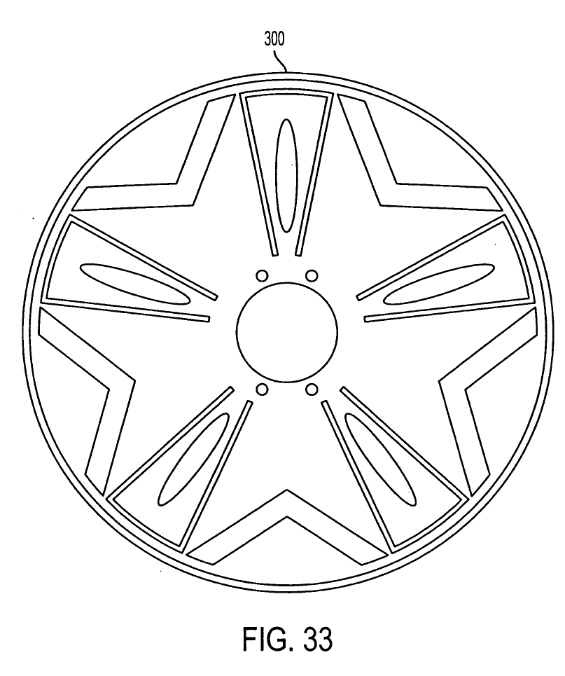

FIG. 32 is a top view of a fourth embodiment of a spinner 200 according to the present invention. In this embodiment, a slit 210 is provided to allow the spinner 200 to be inserted onto the wheel, as in the previous embodiments. Holes 258A and 258B are provided on opposite sides of the spinner 200, each hole 258A and 258B being at a 22° angle with respect to the horizontal dashed line C.

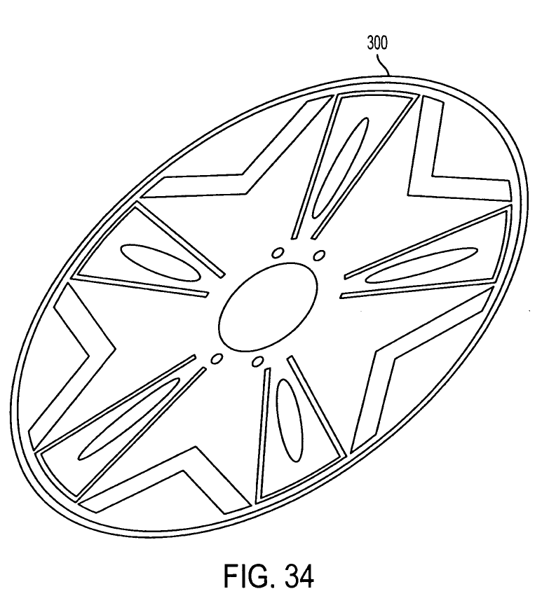

FIGS. 33 and 34 illustrate a top and a perspective view of a spinner 300 according to a fifth embodiment of the present invention. The primary difference between this embodiment and the third and fourth embodiments is the shape of the designs on the spinner. It is within the skill of the ordinary artisan to design the spinner to have openings in any configuration.

The single disk structure, providing a thin single face center, allows die cut manufacturing of the spinner assembly, which reduces development time and costs. Additionally, it allows more styles to be made for less money in a shorter time.

According to one embodiment of the present invention, the hub locks utilize nylon or other low friction plastics to reduce drag and increase the spin time during use. It is also possible according to another embodiment to use roller bearings for a longer smoother spin.

According to one embodiment, the spinner disk or spinner portions are made from a plastic injection molded material and are chrome plated or painted. Alternatively, the spinner disk or spinner assembly components can be made of a metal, such as aluminum, titanium, or other lightweight materials suitable for use on a bicycle. A decorative design or visual pattern may be printed or otherwise included on the spinner. Alternatively, the spinner disk or spinner assembly components may be left in their original metallic color, or painted with another color, such as one which would match the bicycle to which is to be attached.

The spinner assembly can be put on the bicycle hub either after the owner or retailer purchases the bicycle, or the manufacturer can do it during assembly of the bicycle. Further, though the embodiments shown here are illustrated for use on a bicycle, it will be understood by one of ordinary skill in the art that the spinner assembly can be used on other vehicles as well, with changes to the size, and possibly the configuration, of the assembly.

The foregoing description of the specific embodiments will so fully reveal the general nature of the invention that others can, by applying current knowledge, readily modify and/or adapt for various applications such specific embodiments without undue experimentation and without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. The means, materials, and steps for carrying out various disclosed functions may take a variety of alternative forms without departing from the invention.

Thus the expressions “means to . . . ” and “means for . . . ”, or any method step language, as may be found in the specification above and/or in the claims below, followed by a functional statement, are intended to define and cover whatever structural, physical, chemical or electrical element or structure, or whatever method step, which may now or in the future exist which carries out the recited function, whether or not precisely equivalent to the embodiment or embodiments disclosed in the specification above, i.e., other means or steps for carrying out the same functions can be used; and it is intended that such expressions be given their broadest interpretation.

What is claimed is:

1. A spinner assembly to be installed on vehicle wheels having a wheel hub, comprising:
a spinner having at least two members, each of the at least two spinner members having a cut-out portion in an inner portion thereof, and first connectors to connect the two members to one another; and
a hub lock having at least two portions, each of the at least two hub lock members having a cut-out portion in a center edge inner portion thereof to accommodate the wheel hub, and second connectors to connect the at least two hub lock members to one another;
wherein the at least two spinner members and the at least two hub lock members comprise third connectors to connect the at least two hub lock members to the at least two spinner portions.

2. The spinner assembly according to claim 1, wherein the first, second and third connectors comprise a tab and a dimple connector.

3. The spinner assembly according to claim 1 wherein said spinner is provided with a decorative design.

4. The spinner assembly according to claim 1, wherein the hub lock cutout portion is provided in a plurality of different sizes to fit a plurality of different sized hubs.

5. A spinner assembly to be installed on vehicle wheels having a wheel hub, comprising:
a spinner having two semicircular portions, each of the two spinner members having a cut-out portion in an inner portion thereof to accommodate the wheel hub and at least one through hole;
a first hub lock having at least two members;
a second hub lock having at least two members; and
at least one hub lock connector to connect the first and second hub locks to one another through the at least one through hole in the spinner,
wherein for each of the first and second hub locks, each of the hub lock members have a cut-out portion in a center edge inner portion thereof to accommodate the wheel hub.

6. The spinner assembly according to claim 5, wherein the two spinner members comprise at least one spinner connector to connect the two spinner members to one another.

7. The spinner assembly according to claim 6, wherein the at least one spinner connector comprise a tab and a dimple connector.

8. The spinner assembly according to claim 6, wherein the at least one hub lock connector comprises:
at least one first nut formed on an outside face of the first hub lock;
a corresponding at least one peg protruding from an inside face of the first hub lock and adapted to fit through a corresponding at least one through hole in the spinner; and
a corresponding at least one second nut formed on the second hub lock and having a through hole adapted to receive and secure the at least one peg through the corresponding at least one through hole in the spinner.

9. The spinner assembly according to claim 6, wherein the at least one hub lock connector comprises nuts and bolts connecting the hub locks on either side of the spinner.

10. A spinner assembly comprising:
a single disk having a central hole defined therein, and a single slit extending from an outer circumference to the central hole, the central hole being sized to fit around a wheel hub;
two hub locks to be connected to one another, one adjacent to each face of the single disk to define two central holes, each of which is sized to fit around the wheel hub; and
at least one C-ring to be connected to the single disk and hub locks and having a smaller size than that of the central holes of the disk and hub locks to secure the disk and hub locks to the wheel hub.

11. The spinner assembly according to claim 10, wherein the single disk can be mounted on the wheel hub using the slit to by spin the disk through spokes of a vehicle wheel.

12. The spinner assembly according to claim 10, wherein the two hub locks are each formed two hub lock parts which are snapped together around the wheel hub when the spinner assembly is assembled.

13. The spinner assembly according to claim 10, wherein the at least one C-ring comprises four C-rings, each having a central hole of a different size adapted to fit bicycle hubs having different diameters.

14. The spinner assembly according to claim 10, further comprising at least one spacer clamp configured to be clamped on the wheel hub adjacent to an outer one of the C-rings to maintain the spinner in position on the wheel hub during rotation.

15. The spinner assembly according to claim 1, wherein the spinner spins separately from the bicycle hub.

16. The spinner assembly according to claim 5, wherein the spinner spins separately from the bicycle hub.

17. The spinner assembly according to claim 10, wherein the spinner spins separately from the bicycle hub.

18. The spinner assembly according to claim 5, wherein said spinner is provided with a decorative design.

19. The spinner assembly according to claim 10, wherein said spinner is provided with a decorative design.

20. The spinner assembly according to claim 5, wherein the hub lock cut-out portion and the spinner cut-out portion are provided in a plurality of different sizes to fit a plurality of different sized hubs.

21. The spinner assembly according to claim 10, wherein the hub lock cutout portion and the spinner cutout portion are provided in a plurality of different sizes to fit a plurality of different sized hubs.

22. The spinner assembly according to claim 1, wherein said spinner is made from one of a plastic injection molded material or a metal.

23. The spinner assembly according to claim 5, wherein said spinner is made from one of a plastic injection molded material or a metal.

24. The spinner assembly according to claim 10, wherein said spinner is made from one of a plastic injection molded material or a metal.

25. The spinner assembly according to claim 1, wherein the spinner is chrome plated or painted.

26. The spinner assembly according to claim 5, wherein the spinner is chrome plated or painted.

27. The spinner assembly according to claim 10, wherein the spinner is chrome plated or painted.

28. The spinner assembly according to claim 1, wherein said hub locks are made from one of a nylon or other low friction plastic material to reduce drag and increase spin time.

29. The spinner assembly according to claim 5, wherein said hub locks are made from one of a nylon or other low friction plastic material to reduce drag and increase spin time.

30. The spinner assembly according to claim 10, wherein said hub locks are made from one of a nylon or other low friction plastic material to reduce drag and increase spin time.
